(19) United States
(12) Patent Application Publication
(10) Pub. No.: US 2004/0021316 A1
(43) Pub. Date: Feb. 5, 2004

(54) Coupling for charging and venting operations of hydraulic systems

(76) Inventor: Werner Rogg, Villingen-Schwenningen (DE)

Correspondence Address: PENDORF & CUTLIFF, Post Office Box 20445, Tampa, FL, 33634-0445, US

(21) Appl. No.: 10/348,661

(22) Filed: Jan. 22, 2003

(30) Foreign Application Priority Data
Jan. 23, 2002 (DE) 102 02 349.2

(51) Int. Cl. F16L 37/00

(52) U.S. Cl. 285/308

(57) ABSTRACT

Coupling for the axial coupling-in of a nipple (5) for charging or venting of a hydraulic system, comprised of:

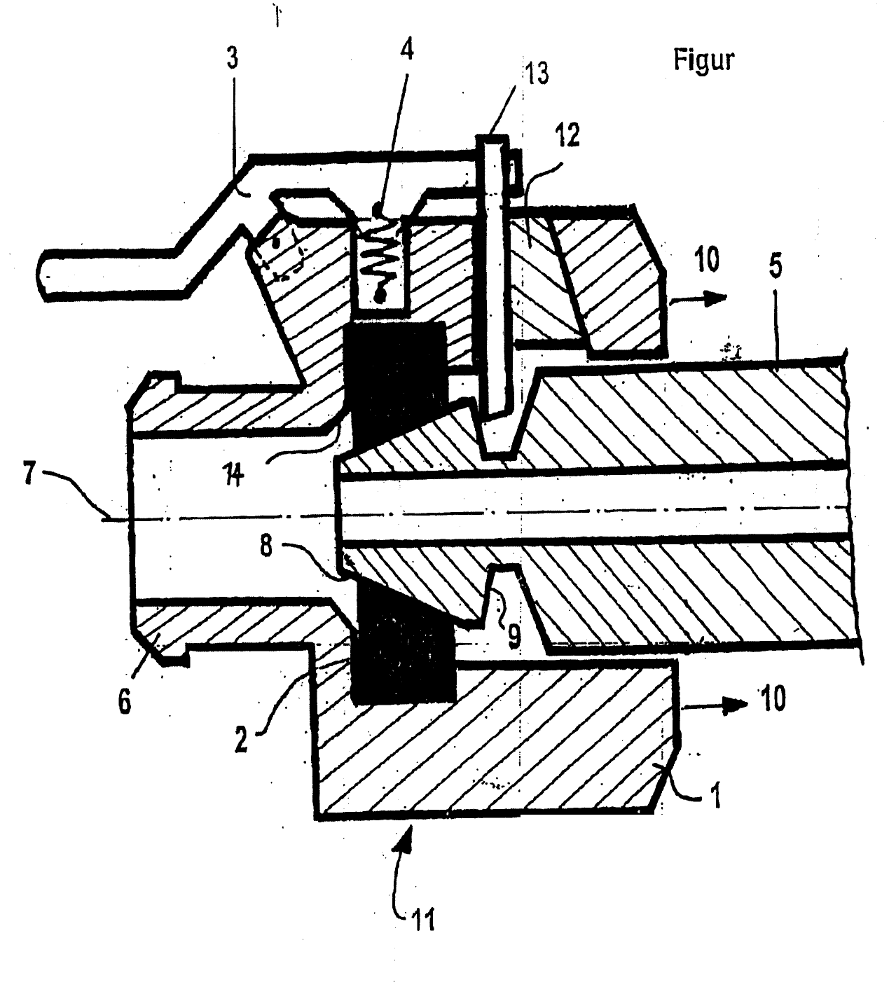

a housing (1) in the form of a hollow cylinder, of which the internal diameter is arranged concentric to an axis (7),

a ring shaped seal (2) seated concentrically within the housing (1) and supported axially on at least one side,

a connecting element (6), at the rearward axial end of the coupling (11) relative to the coupling-in direction (10), for connecting a line in the axial direction,

an opening, at the front end of the coupling (11) relative to the coupling-in direction (10), for introduction of the nipple (5) in the direction towards the seal (2),

a clamp lever (3) mounted radially moveable on the housing (1) for axial fixing of the nipple (5) pressed against the seal (2) relative to the coupling (11), wherein a predetermined axial pressure force exists and wherein the clamp lever (3, 13) engages in a recess in the outer circumference of the nipple (5) spring-biased by a spring (4) supported against the housing (1).

### BACKGROUND OF THE INVENTION

1. Field of the Invention

The invention concerns a coupling for charging and venting operations in hydraulic systems, and in particular for transmission and brake systems, such as those which may be components of motorized vehicles.

2. Description of the Related Art

Transmissions and brake systems frequently utilize hydraulic systems. In order to carry out an initial filling or a routine servicing thereof, these systems include at least one nipple. A suitable hydraulic fluid is supplied from a supply system via a line or a hose, and is introduced into the transmission or brake system via the mentioned nipple. The filling of this type of system generally concludes with the so-called ventilation step, during which air located in predetermined locations is removed to the atmosphere, and in which the time relative to the filling process is considered lengthy.

The most frequently employed supply conduit from a hydraulic supply system to the filling nipple is the high-pressure hose. This hose is provided on its leading end with an adaptor. The adaptor is seated upon the nipple of the hydraulic system and is sealed via an internal rubber ring. To do this, the cylindrical shaped housing representing the substantial part of the adaptor as well as the therein lying ring shaped rubber ring are introduced over the nipple, pressed together in axial direction by movement of a lever, and a sealing is produced with a simultaneous expansion of the rubber ring in the radial direction. The cylindrical shaped body of the adaptor is therein always so constructed, that the nipple receiving opening lies axially opposite the lever for the operation of the seal. The mechanism for pressing together the rubber seal takes up relatively much space. The supply of hydraulic fluid occurs via a high pressure connection, which is oriented radially to the cylindrical shaped adaptor body, that is, presents a supply inlet angled sideways at 90°, as a result of which the device becomes difficult to manipulate. Further, the torque from operation of the lever must be taken up by the adaptor/nipple system.

Now that modern hydraulic systems exhibit various operational and space conditions, not every system can be serviced with the above-described adaptor with its radially oriented supply line.

### SUMMARY OF THE INVENTION

In the invention is concerned with the task of providing a coupling for connecting to a nipple of a hydraulic system, which can be operated within a minimal workspace and in particular is useful for the charging and venting of transmissions or brakes.

This task is solved by the combination of characteristics set forth in claim 1.

Advantageous embodiments can be found in the dependent claims.

The invention is concerned with the recognition, that a coupling for charging and venting processes of hydraulic systems, in particular transmission and brake systems, which can be components of motorized vehicles, can be pressed onto a nipple axially via a ring shaped seal, wherein a radially acting clamping lever provided on the coupling is lockable or fixable upon obtainment of a sufficient application pressure. For this the overall shape of the coupling is a hydraulic cylinder, and includes an axially fixed ring-shaped seal provided in the inside of the housing concentric to a central axis of the coupling, and includes a clamping lever which, so long as a sufficient application pressure exits between the coupling or as the case may be the seal and the nipple, engages or locks in a recess in the outer surface of the nipple, spring biased by a spring which is supported against the housing.

The spring, which is supported against the housing, can be a radially oriented pull or pressure spring, a pull or pressure spring oriented parallel to the access, or a pressure spring.

For fixing axially counter to the coupling-in direction, the seal is supported mainly by a large surface area annual recess provided within the coupling.

The axial design of the coupling makes possible a space saving construction. Beyond this, the supply system directed through the coupling and the nipple is designed to be axially straight, i.e., linear. This means that no bends, in particular no 90° bends, occur as they do in the state of the art. The connecting element present at the back end of the coupling is likewise designed for the axially oriented flow of the supply system.

For the optimal stability or durability of the seal against mechanical and chemical stresses and strains during operation with a hydraulic fluid, this is preferably made with rubber.

The clamping lever for fixing the coupling to the nipple is shown in simple manner as a snap-hook with a latch or lever nose. The snap-hook is pulled spring-biased into the working position and can be pivoted free by hand via a pivotable mounting, whereby the coupling is unlocked. The lever nose is preferably designed to be form-fitting complementary to the above-described recess, in which it engages. Since the recess is conventionally round, the forward end of the lever nose is likewise somewhat concave.

A variation in the coupling dimensions offers a selection and at the same time is a function of the application pressure and the operating pressure which can be present in the conduit system in the coupled-in condition. In the design of the axial distance between the seal of the coupling and the clamping lever, while taking into consideration the dimensions of the nipple, the relative axial position between the clamp lever and nipple in the operating condition is determined and the resulting pressure force which would exist from the deformation of the seal during coupling-in is thus determined. Said another way, the clamping lever in the form of a snap-hook clamps in a recess in the nipple only then, when that minimal necessary force in the axial direction for achieving coupling-in is applied.

For a better contact between the seal and the nipple, the cooperating sealing surfaces on both sides are preferably designed to be conical. Therewith, the service life of the seal can be optimized.

The described coupling is particularly suitable for employment for the charging or ventilation of hydraulic transmissions or brake systems. A hydraulic supply system can therewith be coupled to a charge and ventilation nipple.

Particular advantages of the axial design of the coupling lies in the space saving construction, wherein the length is minimized. Supply lines which require much space, which are connected at right angles to the housing, are avoided. This provides for further opportunities for employment of the coupling, such that also those hydraulic systems can be serviced, of which the connecting nipple is difficult to access.

### BRIEF DESCRIPTION OF THE DRAWING

In the following the invention will be described in greater detail on the basis of schematic, non-limiting figure.

### DETAILED DESCRIPTION OF THE INVENTION

The figure shows a coupling 11 which is coupled to a nipple 5.

The figure shows an adaptor or, as the case may be, a coupling 11 with hose connection, wherein there exists axially a seal between coupling 11 and nipple 5, via a rubber seal 2, with simultaneous affixing via the clamp lever 3. The nipple 5 is part of a hydraulic fluid containing hydraulic system of a transmission or brake system. When connecting the coupling 2 to the nipple 5, the face of the seal 2 is seated upon this conical stump with appropriate axial application pressure, wherein this is defined by the distance between the clamp lever 3, which is in form of a snap-hook, and the seal 2. The connection of the coupling 11 occurs in the axial direction. The connecting element 6 serves, for example, for connection to a hydraulic hose

The design of the coupling 11 is in general that of a hollow cylinder, wherein internally various different diameters exist. Beginning with the part shown at the left side of the figure, in communication with the inner diameter of the connecting element 6 there is a seal receptacle in the form of a recess, which provides the substantial support for the seal 2 in the axial direction. The forward-lying part of the coupling 11 in the coupling-in direction 10 likewise exhibits an opening arranged concentric to the axis 7, adapted for receiving the nipple 5, without substantial play. Pivotably mounted on the housing 1 of the coupling 11 is a clamp lever 3. This clamp lever includes a lever nose 13. This is guided radially inwards through an opening 12 in the housing 1 and, in the coupled-in condition, snaps in preferably form-complementary with the recess 9 in the nipple 5. A bevel 14 provided next to the recess for accepting the seal provides an additional free space for deformation of the seal 2 during the pressing-on of the nipple 5. Simultaneously, the entire system is ready for a charge or venting process. The application pressure is reproducible.

Depending upon the dimensioning of the coupling 11, the pressing-in force can be varied by changing the axial distance between the seal 2 and the radial engaging clamp lever 3. For the part of the nipple 5, as a rule there are standardized nipple shapes, which are appropriately to be taken into consideration. That means that the distance between conical sealing surface 8 and the recess 9 in the form of an annual groove is predetermined. The pressure force for application should be a multiple of the operation pressure existing in the conduit system.

### REFERENCE NUMBER LIST

1 housing

2 seal

3 clamp lever

4 spring

5 nipple

6 connecting element

7 access

8 conical shaped sealing surface

9 recess

10 coupling-in direction

11 coupling

12 opening

13 lever nose

14 bevel

1. Coupling for the axial coupling-in of a nipple (5) for charging or venting of a hydraulic system, comprised of:
a housing (1) in the form of a hollow cylinder, of which the internal diameter is arranged concentric to an axis (7), a ring shaped seal (2) seated concentrically within the housing (1) and supported axially on at least one side, a connecting element (6), at the rearward axial end of the coupling (11) relative to the coupling-in direction (10), for connecting a line in the axial direction, an opening, at the front end of the coupling (11) relative to the coupling-in direction (10), for introduction of the nipple (5) in the direction towards the seal (2), a clamp lever (3) mounted radially moveable on the housing (1) for axial fixing of the nipple (5) pressed against the seal (2) relative to the coupling (11), wherein a predetermined axial pressure force exists and wherein the clamp lever (3, 13) engages in a recess in the outer circumference of the nipple (5) spring-biased by a spring (4) supported against the housing (1).

2. Coupling according to claim 1, thereby characterized, that the hydraulic system is a hydraulic transmission or brake system.

3. Coupling according to claim 2, thereby characterized, that the coupling or brake system is a component of a motorized vehicle.

4. Coupling according to one of the preceding claims, thereby characterized, that the seal (2) is comprised of rubber.

5. Coupling according to one of the preceding claims, thereby characterized, that the clamp lever (3) is provided with a lever nose (13) in the form of a snap-hook.

6. Coupling according to one of the preceding claims, thereby characterized, that the axial pressure force between the seal (2) and the nipple (5) is a multiple of the operating pressure of the medium conveyed in the coupling (11) and the nipple (5).

7. Coupling according to one of the preceding claims, thereby characterized, that the seal (2) and the nipple (5) respectively exhibit conically cooperating sealing surfaces.

8. Coupling according to one of the preceding claims, thereby characterized, that the spring is a radially oriented pull or pressure spring (4), a pull or pressure spring arranged parallel to the axis (7), or a pressure spring.

9. Coupling according to one of the preceding claims, thereby characterized, that the lever nose (13) is shaped form-complementary to the recess (9).
